(19) United States
(12) Patent Application Publication
(10) Pub. No.: US 2002/0070627 A1
(43) Pub. Date: Jun. 13, 2002

(54) Stator core design

(76) Inventors: Robert W. Ward, Anderson, IN (US); Brett McNeil, Middletown, IN (US)

Correspondence Address: Kenneth I. Kohn, KOHN & ASSOCIATES, Suite 410, 30500 Northwestern Highway, Farmington Hills, MI, 48334, US

(21) Appl. No.: 09/947,993

(22) Filed: Sep. 6, 2001

Related U.S. Application Data
(60) Provisional application No. 60/230,451, filed on Sep. 6, 2000.

(51) Int. Cl. H02K 1/00

(52) U.S. Cl. 310/254; 310/216

(57) ABSTRACT

According to the present invention, there is provided a stator core including a body portion having an inner and outer surface and integral retaining mechanism extending radially from the body portion for retaining a coil of wire about at least one of the inner and outer surfaces. The present further provides for a stator core assembly including at least two stator cores having a body portion with an inner and outer surface and integral retaining mechanism extending radially from the body portion for retaining a coil of wire about at least one of the inner and outer surfaces. The retaining mechanism is further defined as having a surface perpendicular with the inner and outer surface of material and a surface parallel and axial with the inner and outer surface to form a three-sided retaining mechanism thereby forming a three-sided pocket space about the body portion. Further, the present invention provides for a method of making a stator core by shaping a mixture of powdered iron material into a predetermined stator core including a body portion having an inner and outer surface and integral retaining mechanism extending radially from the body portion for retaining a coil of wire about at least one of the inner and outer surfaces and curing the mixture of powdered iron material to fuse the mixture of powdered iron material together to form the stator core.

### CROSSREFERENCE TO RELATED APPLICATIONS

This application claims the benefit of priority under 35 U.S.C. Section 119(e) of U.S. Provisional patent application Ser. No. 60/230,451, filed Sep. 6, 2000, which is incorporated herein by reference.

### BACKGROUND OF THE INVENTION

1. Field of the Invention

The present invention generally relates to the field of stators assemblies and stator cores. Particularly, the present invention is directed towards an improved stator design for use in electrical machines, motors or generators.

2. Description of Related Art

Various stator assemblies are well known in the art. Generally, they are utilized in different electrical machines such as generators, motors, or other similar devices. A stator assembly or an armature assembly have a “core” that is made of material composed of magnetically conductive material. Typically, the Stator Assembly is stationary and holds a coil or coils of wire through various slots or holes circumferentially and evenly located around the ring.

The stator cores are constructed from numerous sheets of steel, which have been shaped into rings with a desired number of slots or holes cut into each ring. The shapes, number, and overall size of the slots or holes are determined by the design of the particular stator or stator core. These pieces of sheet steel, also known as laminations, are often approximately 0.014 inch thick. Once the rings with the slots or holes are formed from the laminations, several lamination rings are stacked on top of each other so that the slots or holes are aligned properly. This stack of laminated rings form a complete stator core. As a result of the alignment of the slots or holes, “poles” are formed that in essence surround the slots or holes. The slots or holes located around the circumference of the stator ring provide a place for wires to be held and the wires usually wrap around the poles of the ring. The wires continue around the circumference of the stator ring. In typical stators, there are three shaped wires also known as phases, which are placed around the stator. A phase is simply one conductor or a series of conductors fastened together to act simultaneously as one.

The wires located around the circumference of a stator or stator core typically are made of material including, but not limited to, copper, metal, alloys, and any other similar electrically conductive metal or material known to those of skill in the art. The wires are assembled and arranged within the slots or holes of the stator according to the determined design. The wires are placed within the slots or holes and wrap around the poles. These poles direct the magnetic flux to or from the wires. There are various wire winding designs or configurations that use a stator that always results in inefficiencies in the wire windings because these “slotted stator core” designs always have some length of wire material in “end turns.” These wire end turns are not only a waste of material, but also result in loss of efficiency incurred in a motor or a generator. Further, a large amount of heat is generated from them that causes an increase in temperature of the engine and/or surrounding.

The stators or stator cores either can be used to generate an electric current or transfer electric currents to create a magnetic flux, which in turn can be used to create mechanical energy. For instance, an armature or any claw-shaped and round device that has magnetic properties, can be placed within the stator. The poles located on the stator also can have magnetic properties. Thus, if energy is initially transferred to the armature to cause it to rotate about its axis, then the magnetic flux created from the rotation of the magnetic armature transfers to the poles of the stator. The magnetic flux then is translated into electrical current, which flows through the wires surrounding the stator. In the alternative, electric currents can be conducted through the wires, which in turn creates magnetic flux in the poles. The magnetic flux then transfers to the magnetic armature to cause the armature to rotate about its axis.

In a conventional rotor for an alternating current generator, each permanent magnet in the generator is inserted between the circumferential side faces of two adjacent claw-like magnetic poles of Lundell-type pole cores to diminish the magnetic flux leakage between a plurality of claw-like magnetic poles. At the same time, the magnetic flux of the permanent magnets is directed toward the field coil or field winding to improve the output efficiency. The output efficiency is the electric power generating efficiency of the stator core.

When Lundell-type pole cores rotate, strains are generated on the permanent magnets in the direction of the centrifugal force. Therefore, conventional devices require an arrangement where the permanent magnets do not protrude from the area between the circumferential side faces of two adjacent claw-like magnetic poles.

There are numerous patents relating to the present invention. For instance, U.S. Pat. No. 5,385,410 to Shirai et al discloses an integral variable resistant sensor and bearing grease seal sensor assembly having at least one magnet and an annular wire coil secured at the interior of a housing that seals an annular space between a dynamic inner race and a static outer race.

U.S. Pat. No. 5,038,066 to Pawlak et al is directed towards an actuator having a permanent magnet ring with a plurality of radially magnetized poles rotatably positioned between a pair of toothed pole pieces with interdigitated teeth. The device disclosed therein is used as a two or three position actuator or as an actuator operating against an external force and seeking a position as a function of current.

Additional stator core-related patents include U.S. Pat. No. 4,947,065 to Ward, U.S. Pat. No. 4,174,485 to Soden et al, U.S. Pat. Nos. 6,211,594 and 6,204,586 to Umeda et al, and U.S. Pat. No. 5,576,584 to Kusumoto et al. All of these references listed are further incorporated herein by reference in their entirety.

Accordingly, it would be desirable to have an improved stator that is more efficient and provides greater flux. Additionally, it is desirable to have an improved stator that is lighter and more compact.

### SUMMARY OF THE INVENTION

According to the present invention, there is provided a stator core including a body portion having an inner and outer surface and integral retaining mechanism extending radially from the body portion for retaining a coil of wire about at least one of the inner and outer surfaces. The present further provides for a stator core assembly including at least two stator cores having a body portion with an inner and outer surface and integral retaining mechanism extending radially from the body portion for retaining a coil of wire about at least one of the inner and outer surfaces. The retaining mechanism is further defined as having a surface perpendicular with the inner and outer surface of material and a surface parallel and axial with the inner and outer surface to form a three-sided retaining mechanism thereby forming a three-sided pocket space about the body portion. Further, the present invention provides for a method of making a stator core by shaping a mixture of powdered iron material into a predetermined stator core including a body portion having an inner and outer surface and integral retaining mechanism extending radially from the body portion for retaining a coil of wire about at least one of the inner and outer surfaces and curing the mixture of powdered iron material to fuse the mixture of powdered iron material together to form the stator core.

### DESCRIPTION OF THE DRAWINGS

Other advantages of the present invention will be readily appreciated, as the same becomes better understood by reference to the following detailed description when considered in connection with the accompanying drawings wherein:

FIG. 1 is an illustration of prior art stator core assemblies, wherein

FIG. 1A is a top-view of a stator core assembly showing numerous slots and poles,

FIG. 1B is a side-view of the stator core assembly showing numerous laminations, and

FIG. 1C is a side-view of the stator core assembly including wires wrapped around the poles and within the slots therein;

FIG. 2 is a perspective view of an embodiment of the present invention wherein four stator core rings are stacked together, whereby the arrows illustrate the magnetic current for three separate wire coils or phases placed and sandwiched in a space between and within the rings and the configuration routes or directs the magnetic flux for each coil to encircle each coil as shown by a pair of arrows, wherein each phase of the coil windings is of a certain number of turns around the inner surface of the ring that fits between rings, whereby the ends of the wire exit the embodiment of the present invention through holes;

FIG. 3 is a perspective view of an embodiment of the present invention wherein the individual stator core rings are shown separately;

FIG. 4 is a perspective view of another embodiment of the present invention, wherein the embodiment is a center stator core ring;

FIG. 5 is a perspective view of another embodiment of the present invention, wherein the embodiment is an end capped stator core ring;

FIG. 6 is perspective view of another embodiment of the present invention, wherein the stator core ring assembly is completely capped and sealed; and

FIG. 7 is a perspective view of another embodiment of the present invention, wherein the entire stator core ring assembly includes retaining mechanisms that completely enclose the wire within the stator core assembly.

### DETAILED DESCRIPTION OF THE INVENTION

The present invention provides for a stator core generally indicated at 12 and stator core assembly generally shown at 10. The stator core 12 includes an body portion having an inner 13 and outer 15 surface and integral retaining mechanism 14 extending radially from the body portion 11 for retaining a coil of wire about at least one of the inner 13 and outer 15 surfaces. The stator core assembly 10 includes at least two stator cores 12. The retaining mechanism 14 is designed to retain and hold wires 16 concentric with the body portion 11 and to direct magnetic flux along an axis of the body portion 11.

The term “armature” as used herein is meant to include, but is not limited to, a machine part having coils of wire around a metal core in which electric current is induced in a generator or the input current interacts with a magnetic field to produce torque in a motor. Basically, the armature is the rotating part of an electromagnetic device.

The terms “stator,” 10 “stator core,” 10 “stator core ring,” 12 and “stator core assembly” 10 as used herein are meant to include, but are not limited to, stationary machine parts in or about which a rotor revolves. The stator 10 is well-suited for use in a thermally hostile or chemically hostile environment or both. Typically, the stator is annular in shape, but can be any shape having an interior space for placement of a revolving rotor. The stator 10 is made from materials including, but not limited to, iron, iron ore, metal, powdered elemental iron, alloys, combinations thereof, and any other similar materials known to those of skill in the art.

The term “wire” 16 as used herein is meant to include, but is not limited to, copper, aluminum, metal, metal composites, and any other similar electrically conductive wire known to those of skill in the art. The wire 16 sometimes is used in pairs to create a wire coil phase. The ends 18 of the wires 16 exit the stator core through predetermined holes on the stator core ring 12 are connected to the desired and appropriate device so that electric current flows to or from the stator core 10.

The term “elemental iron” as used herein is meant to include, but is not limited to, a purified form of iron material generally consisting of pure elemental iron. Description of elemental iron and the method of making it is described more fully in U.S. patent application Ser. No. 09/705,434 to applicant, which is incorporated herein by reference in its entirety.

The term “shaped mold” as used herein is meant to include, but is not limited to, a prefabricated frame, cavity, fixed form and any other similar structure known to those of skill in the art. The shape mold is for forming a stator that typically is annular in shape.

The term “sintering” as used herein is meant to include, but is not limited to, the process of causing particles to become a coherent mass through heating the particles without melting them or any other similar heating process known to those of skill in the art. Sometimes, however, sintering causes some of the iron particles in the compacted part to be in a liquid state.

The term “curing” as used herein is meant to include, but is not limited to, a process of treating a compacted part made of ferrous and non-ferrous particles. The process does not melt or weld together the ferrous particles to each other. Rather, the non-ferrous materials included in the mixture of ferrous particles cause the mixture of materials to fuse together in order to increase the strength of the compacted part.

The term “annealing” as used herein is meant to include, but is not limited to, heat, fire, heat and cool, and any other similar process known to those of skill in the art.

The term “soldering” as used herein is meant to include, but is not limited to, a method of uniting metallic surfaces thereof.

The term “alloy” as used herein is meant to include, but is not limited to, a substance composed of two or more metals, nonmetals, and any combinations thereof.

The term “phase” as used herein is meant to include, but is not limited to, a single electrical conductor or a series of electrical conductors connected to function as a complete circuit. The single electrical conductor can be a wire 16 that typically has many loops to form a coil. The individual loops in each coil are in series and the voltage developed in each loop is added to the voltage developed in all the other loops to produce a total coil voltage. Additionally, each coil can be in series with other coils in a winding to produce a total winding voltage. The present invention utilizes at least one phase, but can use many more depending upon the desired design with the rings 12 and overall design of the stator 10. Three phases are most common in automotive generators, but a single phase is simplest and used in other motor types.

Preferably, each phase winding must be able to withstand a voltage amount of approximately 1000V RMS applied between itself and any other phase winding and the lamination ASM without exhibiting a short.

The term “tab(s)” 14 as used herein is meant to include, but is not limited to, an extended portion of the outer circumference of material 13 of the stator core ring 12 designed to hold the wire 16 placed therein and for directing magnetic flux around the wire and along the axis of the stator core ring 12.

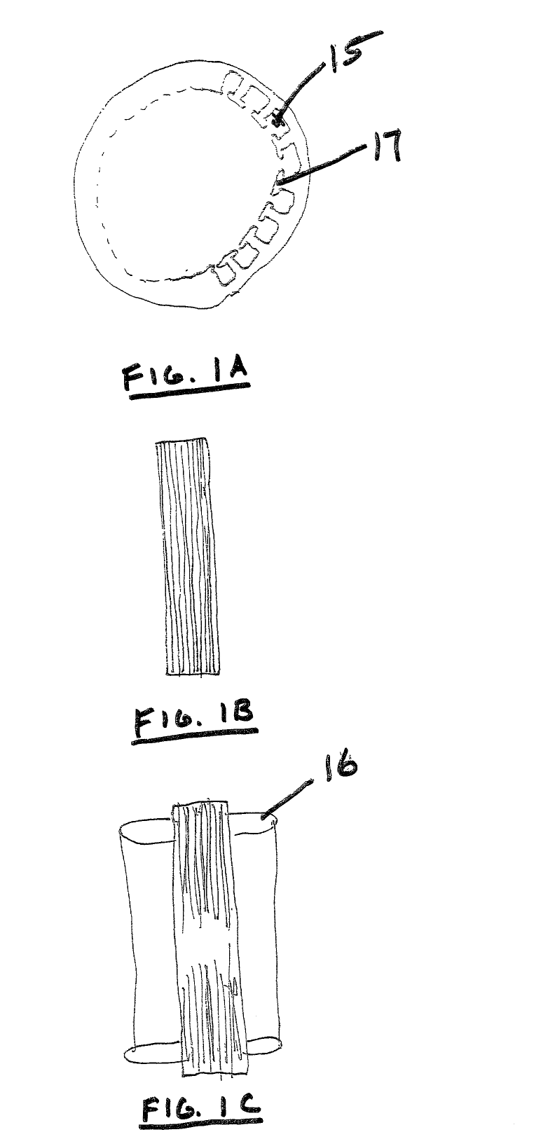

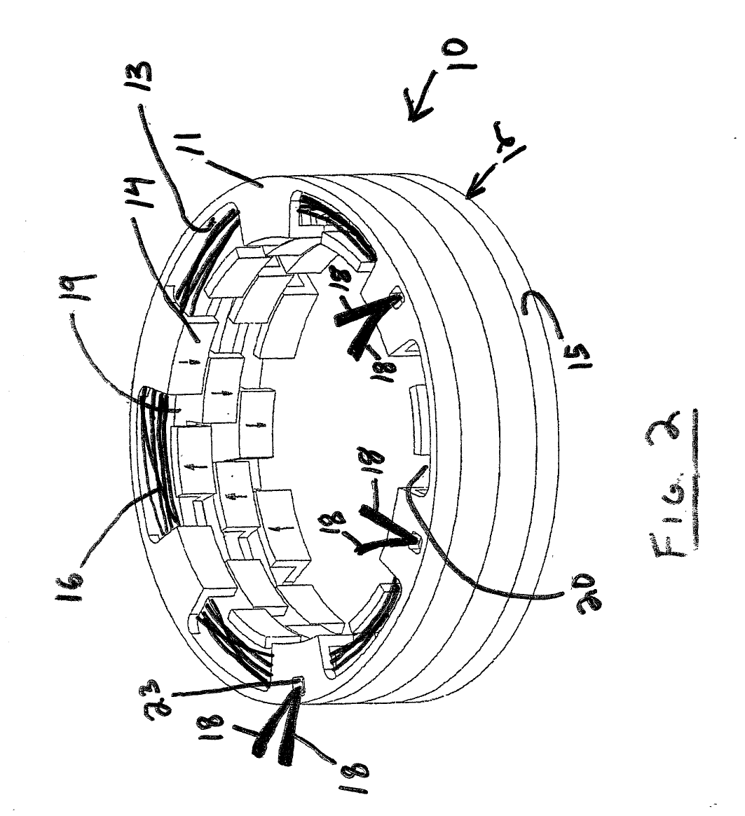

The term “pole” 17 as used herein is meant to include, but is not limited to, a portion of the stator, such as the tabs 14 of the stator core rings of the present invention disclosed herein, which directs magnetic flux, as indicated by the arrows in FIG. 1, along the axis of the stator core ring to or from the wires 16 located on or around the stator core ring 12.

The present invention is well suited for use in various settings including, but not limited to, AC and DC motors, generators, and any other similar electric devices known to those of skill in the art. The present invention is physically strong and capable of surviving thermally and chemically hostile environments such as those found in the engine compartment of automobiles, trucks, generators, and the like. The present invention is made from various materials including, but not limited to, iron, iron ore, powdered elemental iron, various ferrous metals, metals, alloys, and any other similar materials known to those of skill in the art.

The present invention is specifically configured for replacing new or pre-existing 137 millimeter outside diameter stator cores, which presently are used in a Lundell-type automotive generator. The present invention however, is not limited to a particular generator, but is capable of being used for all electric motors and generators. The present invention is directly applicable for designing many more new configurations of stator cores.

In an embodiment of the present invention, there is provided a stator core 12 including a body portion 11 having an inner 13 and outer 15 surface and integral retaining mechanism 14 for retaining a coil of wire 16 about at least one of the inner 13 and outer 15 surfaces.

The body portion 11 and retaining mechanism 14 are made from material including, but not limited to, iron, metals, powdered iron, alloys, and any other similar strong and conductive material known to those of skill in the art.

The retaining mechanism 14 directs magnetic flux to or from the coil of wire 16. The magnetic flux is shown through the arrows indicated in FIG. 1. Further, the retaining mechanism 14 is located adjacent to and cooperates with other retaining mechanisms 14. There can be a plurality of retaining mechanisms 14, depending upon design and size of the stator core 12. Since each retaining mechanism 14 serves to direct magnetic flux, it is equivalent to the poles 17 located on traditional stator core designs. Therefore, depending upon the number of poles and relative strength of magnetic flux, the size and number of retaining mechanisms 14 accordingly vary.

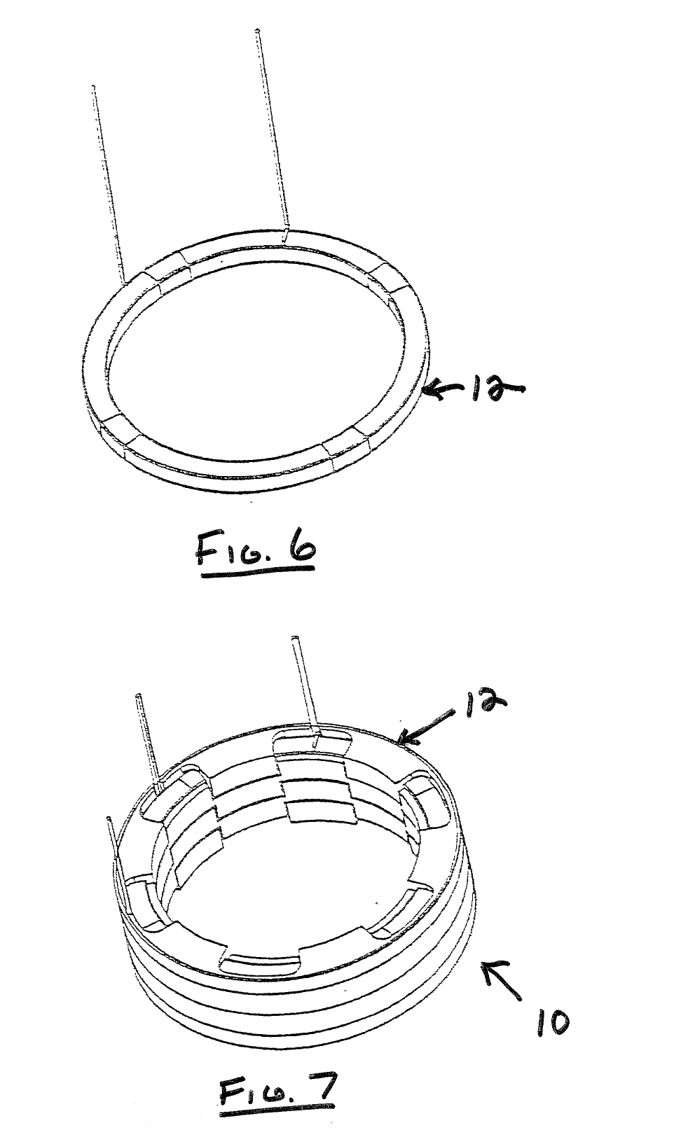

The retaining mechanism 14 is evenly spaced about the body portion 11 of the ring 12. Generally, but not essential nor desirable in all configurations, each retaining mechanism 14 includes a corresponding retaining mechanism 14 disposed on the opposite side of the body portion 11 of the stator core 12. The retaining mechanism 14 can be arranged so that there are open spaces 19 placed evenly around the body portion 11 of the stator core 12. The stator cores 12 can be designed this way in order to minimize the amount of material used and for creating a lighter stator core 12. Alternatively, the stator core ring 12 can be designed to have the retaining mechanism 14 touching each other so that a sealed and capped stator core 12 is formed (See, FIGS. 6 and 7).

The retaining mechanism 14 retains the coil of wire 16 about at least one of the inner 13 and outer 15 surfaces of the body portion 11 of the stator core 12. Thus, the retaining mechanism 14 can retain the coil of wire 16 inward or outward from the body portion 11 of the stator core 12. Additionally, the retaining mechanism 14 can retain the coil of wire 16 both inwardly and outwardly from the body portion 11 of the stator core 12. Further, the retaining mechanism 14 can include a hole 23 that is used an exit for the ends 18 of the coil of wire 16. The hole 23 can be bored into the retaining mechanism 14 after the stator core ring 12 is made, or the hole can be created at the same time that the stator core ring 12 is made.

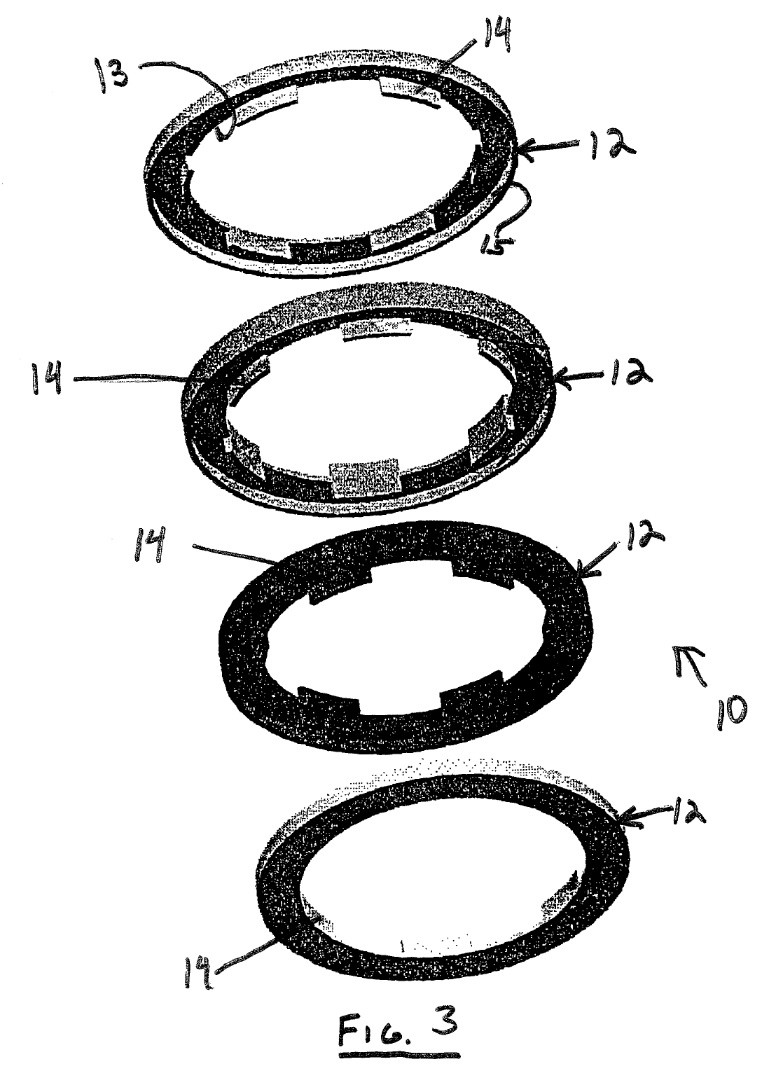

In an embodiment of the present invention, the retaining mechanism 14 is defined as, but not limited to three-sided tabs 14 made from material including, but not limited to, iron, metals, powdered iron, alloys, and any other strong and conductive material known to those of skill in the art. These tabs 14 have a surface perpendicular with the inner 13 and outer 15 surfaces of the body portion 11 of the stator core 12 and a surface parallel and axial with the inner 13 and outer 15 surfaces to form three-sided tabs (See, FIGS. 2-5). These tabs 14 form an interior pocket 20 in which the coil of wire 16 is retained therein.

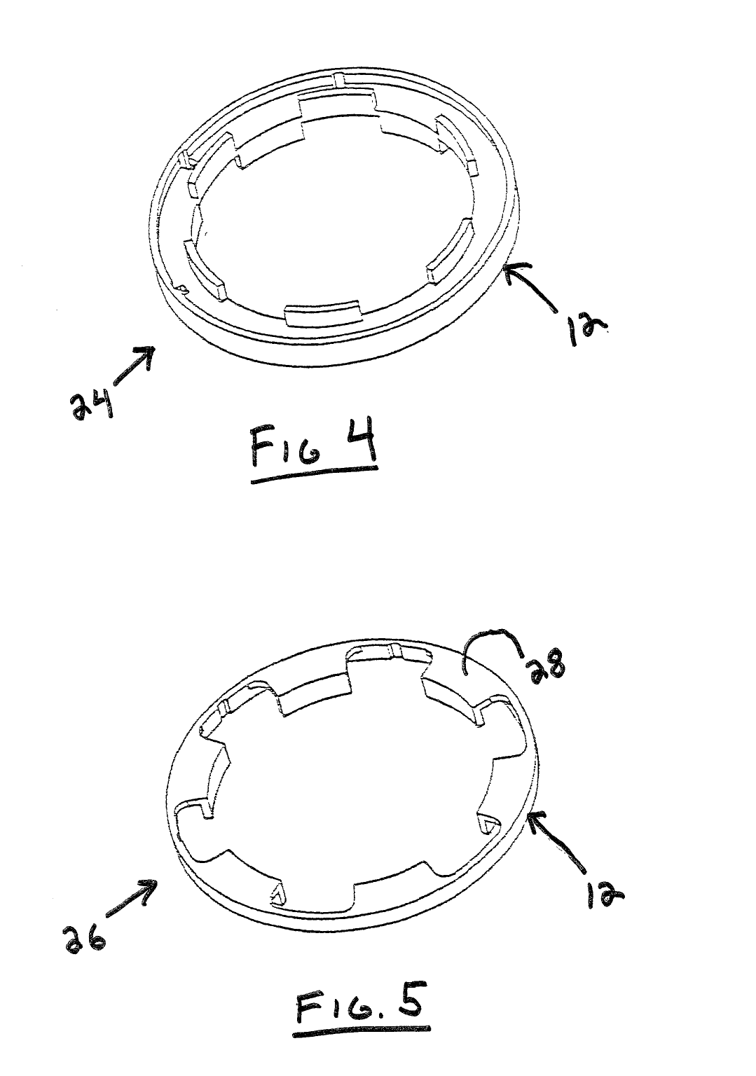

Another embodiment of the present invention is a stator core assembly 10 that includes at least two stator cores 12 having an inner 13 and outer 15 surface and integral retaining mechanism 14 extending radially from the body portion 11 for retaining the coil of wire 16 about at least one of the inner 13 and outer 15 surfaces. These stator cores 12, as previously described herein, can be either an interior stator core, generally indicated at 24 in FIG. 4, or can be an exterior stator core, generally indicated at 26 in FIG. 5. The exterior stator core 26 has a top or cap portion 28 to further retain the coil of wire 16.

Typically, the stator core assembly 10 includes four stator cores 12. The rings 12 are stacked on top of each and are usually two exterior stator cores 26 and two interior stator cores 24. As a result, three interior pockets 20 are formed from the three-sided retaining mechanism 14 of one interior 24 or exterior 26 stator core cooperating with the three-sided retaining mechanism 14 of another exterior 26 or interior 24 stator core in order to retain three coils of wire 16. Of course, the number of stator cores 12 can vary resulting in changing the number of interior pockets that are formed thereof. Additionally, the size of the pockets 20 vary due to the type and size of wire 16 used and by the number of phases that is desired.

As discussed above, an embodiment of the present invention is a stator core assembly 10 having “three wire windings” 16 commonly known as three phases as contained in the high volume automotive stator assembly. The wire windings 16 are three coils of wire 16 sandwiched in three pockets 20 formed from the four stator cores 12 stacked on top of each other. Currently, the typical three phase wire winding techniques widely practiced today by both motor and generator manufacturers around the world is complicated by comparison to the present invention. In contrast to typical wire windings as described above, the present invention simplifies the winding process by keeping the wires compact and within the stator cores 12. These wire windings 16 can be connected through any electrical connector including, but not limited to, a delta connector, Y connector, or any other similar connector known to those of skill in the art.

The present invention accommodates for variations in the wire 16 windings. For instance, the wire windings can be placed concentric with the circumference of the stator core 12 or can span 120 degrees. There are an infinite number of ways to configure the coils. Other configurations of the wire windings include, but are not limited to two or more coils can be retained within a single pocket, coils can be oval, rectangular, or “arc” shaped, hoop-shaped, or any other similar winding known to those of skill in the art. The stator cores 12 and stator core assembly 10 of the present invention are made through various processes. In one embodiment, the process that is utilized involves molding powdered ferromagnetic material into shapes as generally shown in FIGS. 2-7. These shapes can be machined from blocks of the material. In one embodiment, however, the process of forming the stator cores 12 of the present invention includes obtaining sizable pieces of elemental iron that have been purified through any process that does not involve melting the iron ore. The purifying process occurs through reducing the iron ore to a highly pure metallic iron through the reaction with hot gases to reduce or to remove the oxygen and the impurities. Of course, any other similar purifying process that involves purifying the iron ore without melting it also can be employed. Alternatively, water or gas atomized iron and steel powders or any other similar processed powders known to those of skill in the art can be used as the material to form the stator cores 12 and stator assemblies 10 of the present invention.

Upon obtaining the pieces of material, the pieces go through a grinding process that forms even smaller fragments or particles. The grinding process includes using manual, mechanical and any other similar pulverizing, physical force. There are numerous ways of effectively reducing the iron chips into a powdered iron material. Other mechanisms and methods to reduce the iron chips into finished, ready to use powdered iron material can also be employed to produce satisfactory results. Once the powdered iron material is created, a screening process takes place to select iron particles of desirable sizes. Screening can be done through any numerous processes that include, but are not limited to manual, mechanical, magnetic, electrical forces and any other similar force or method known to those of skill in the art. The mixture of powdered iron material particles range in size from approximately 5 microns to approximately 400 microns. Thus, once the particles are screened, the desired ratio of sized particles is selected and then blended to form a mixture of various sized powdered iron material.

The blended powdered iron material can be used to produce an easily prepared mass of ferromagnetic particles, which are capable of being readily compressed or injection molded to form the stator cores 12. The stator cores 12 are made by placing the powdered iron material into a predetermined shaped mold. The mold varies in size, shape and configuration to form the desired stator cores 12. Thus, the size of the body portion 11 can be varied accordingly. Also, the shape of the body portion 11 can vary from the typical annular shape as described herein as an embodiment of the present invention. Furthermore, the retaining mechanism 14 varies in size, shape, and number. Thus, there can be spaces 19 placed between each of the retaining mechanisms 14 or the entire stator core can be a completely enclosed stator core as generally shown in FIGS. 6 and 7. Finally, the stator cores 12 can be made to have various grooves, spaces, and/or holes 23.

After being placed in the mold, the powdered iron material is then compacted using processes known to those of skill in the art. Following compaction, the powdered iron material is cured using techniques known to those of skill in the art. The curing and compaction steps fuse the mixture of powdered iron material together to form the desired article.

Other steps can be added to the preferred embodiment to improve the processibility and enhance the value of the iron powders. Two such processes include blending the powdered iron material with other sizes of powdered iron particles and annealing the iron powered mixture in order to soften and further purify the powdered iron material. All of these additional processes aid to raise the iron density of the articles made. Any material can be added to form an alloy material that has specific magnetic, processing, and strength requirement properties. Thus, the various materials added create an alloy mixture. The material added can be ferrous, nonferrous, metal, nonmetal or any combinations thereof. The materials include, but are not limited to, nickel, silicon, thermoplastics such as nylon, thermosets such as phenolics or epoxies, and any other similar materials known to those of skill in the art. Moreover, lubricants can be added to the mixture of powdered iron material. Lubricants that can be added include, but are not limited to, acruwax, lithium sterate, zinc sterate, graphite, plastics, thermoplastics, thermosets, and any other similar agents known to those of skill in the art.

Once a stator core ring 12 is formed, the stator core assembly 10 can be formed by assembling various exterior 26 or interior 24 stator cores together. First, the wires 16 are placed within the stator cores 12 and the ends 18 of the wires are threaded through the holes 23 of the stator cores 12. Then, the stator cores are fastened together to form the stator core assembly 10. Alternatively, the stator cores 12 can be simply snapped together into place.

As for the wire coil windings 16, they can be formed before the stator core 12 is formed or be formed to fit the stator core 12. In the former case, the wire coil windings 16 can be shaped into any desired geometry or configuration. Thus, the wire coil windings 16 can be coiled and wound in any desired shape with the aid of any tooling device known to those of skill in the art. Then, the stator core 12 itself is molded or formed around the wire coil windings 16 in accordance to the shape and configuration of the wire coil windings 16 thereof.

In the alternative, the wire coil windings 16 can be formed and fitted according to a created stator core 12. Thus, the stator core 12 predetermines the wire coil windings 16 configuration, as opposed to the wire coil windings 16 determining the shape, size, and configuration of the stator core 12 and thus stator core assembly 10. In either situation, the stator core 12 and stator core assembly 10 can be made in accordance with the method disclosed herein or in any other similar method known to those of skill in the art.

Throughout this application, various publications, including U.S. patents, are referenced by author and year and by patent number. Full citations for the publications are listed below. The disclosures of these publications and patents in their entireties are hereby incorporated by reference into this application in order to describe more fully the state of the art to which this invention pertains.

The invention has been described in an illustrative manner, and it is to be understood that the terminology used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

What is claimed is:

1. A stator core comprising:
a body portion including an inner and outer surface; and
integral retaining means extending radially from said body portion for retaining a coil of wire about at least one of said inner and outer surfaces.

2. The stator core according to claim 1, wherein said body portion is annular.

3. The stator core according to claim 1, wherein said body portion is made of material selected from the group consisting essentially of iron, metals, powdered iron, and alloys.

4. The stator core according to claim 1, wherein said retaining means is made from material selected from the group consisting essentially of iron, metals, powdered iron, and alloys.

5. The stator core according to claim 1, wherein said retaining means directs magnetic flux to the coil of wire.

6. The stator core according to claim 1, wherein said retaining means directs magnetic flux from the coil of wire.

7. The stator core according to claim 1, wherein each said retaining means is located adjacent to and cooperates with other said retaining means.

8. The stator core according to claim 1, wherein each said retaining means is evenly spaced around the circumference of material.

9. The stator core according to claim 1, wherein said retaining means retains a coil of wire radially and axially inward from said body portion.

10. The stator core according to claim 1, wherein said retaining means retains a coil of wire radially and axially outward from said body portion.

11. The stator core according to claim 1, wherein said retaining means is defined as tabs made from material selected from the group consisting essentially of iron, metals, powdered iron, and alloys.

12. The stator core according to claim 11, wherein said tabs are further defined as having a surface perpendicular with said inner and outer surface and a surface parallel and axial with said inner and outer surface to form three-sided tabs.

13. The stator core according to claim 1, wherein said tabs further include a hole for placement of the wire.

14. The stator core according to claim 1, wherein the coil of wire is made from materials selected from the group consisting essentially of copper, metals, and alloys.

15. A stator core assembly comprising at least two stator cores including a body portion having an inner and outer surface and integral retaining means extending radially from said body portion for retaining a coil of wire about at least one of said inner and outer surfaces.

16. The stator core assembly according to claim 15, wherein said stator cores are made from materials selected from the group consisting essentially of iron, metals, powdered iron, and alloys.

17. The stator core assembly according to claim 15, wherein said stator cores cooperate with each other to form a channel for placement of the coil of wire.

18. The stator core assembly according to claim 17, wherein said channel is formed from said retaining means of one said stator core and said body portion of another said stator core.

19. A method of making a stator core by:
shaping a mixture of powdered iron material into a predetermined stator core including a body portion having an inner and outer surface and integral retaining mechanism extending radially from the body portion for retaining a coil of wire about at least one of the inner and outer surfaces; and
curing the mixture of powdered iron material to fuse the mixture of powdered iron material together to form the stator core.

20. The method according to claim 19, wherein said shaping step is further defined as shaping the powdered iron material into a stator core including an annularly shaped body portion.

21. The method according to claim 19, wherein said sintering step further includes annealing the mixture of powdered iron material.

22. The method according to claim 19, further including adding various materials selected from the group consisting essentially of nickel, silicon, thermoplastics, lubricants, and thermosets.

23. The method according to claim 19, further including assembling at least two stator core to form a stator core assembly.

24. The method according to claim 19, wherein said assembling step further includes soldering the stator cores together.

25. A method of forming a stator core by:
molding powdered materials around at least one coil of wire to form a stator core including a body portion having an inner and outer surface and integral retaining mechanism extending radially from the body portion for retaining the coil of wire about at least one of the inner and outer surfaces; and
curing the molded powdered materials to fuse the mixture of powdered iron material together to form the stator core.

26. A stator core assembly comprising at least two stator cores including a body portion having an inner and outer surface and integral retaining means extending radially from said body portion for retaining a coil of wire about at least one of said inner and outer surfaces, said retaining means having a surface perpendicular with said inner and outer surface and a surface parallel and axial with said inner and outer surface to form a three-sided retaining means, thereby forming a three-sided pocket space about said body portion.
